(19) United States
(12) Patent Application Publication
(10) Pub. No.: US 2005/0030301 A1
(43) Pub. Date: Feb. 10, 2005

(54) Control of optical switching apparatus

(75) Inventors: Jonathan Harrold, Warwickshire (GB); Graham J. Woodgate, Oxfordshire (GB)

Correspondence Address: FOLEY & LARDNER, 150 EAST GILMAN STREET, P.O. BOX 1497, MADISON, WI, 53701-1497, US

(73) Assignee: Ocuity Limited

(21) Appl. No.: 10/867,579

(22) Filed: Jun. 14, 2004

(30) Foreign Application Priority Data
Dec. 14, 2001 (GB) 0129992.4

(51) Int. Cl. G09G 5/00

(52) U.S. Cl. 345/204

(57) ABSTRACT

Control methods and apparatus for controlling driving of switchable display devices are described. The switchable display devices may be switchable between a 2D display mode and a 3D autostereoscopic display mode. Control apparatus (1455) comprising a display mode module (1465), an image data module (1470), an authorisation module (1475), a controller (1480) and a driver module (1485) is described.

The present invention relates to control methods and apparatus for controlling optical switching apparatus which may comprise driving of display devices that are switchable with respect to provision of different light output directional distributions. Such display devices include, but are not limited to, display devices that are switchable between a two dimensional (2D) display mode and a three dimensional (3D) autostereoscopic display mode. The control method and apparatus of the present invention may be used in computer monitors, telecommunications handsets, digital cameras, laptop and desktop computers, games apparatuses, automotive and other mobile display applications.

3D displays

Normal human vision is stereoscopic, that is each eye sees a slightly different image of the world. The brain fuses the two images (referred to as the stereo pair) to give the sensation of depth. Three dimensional stereoscopic displays replay a separate, generally planar, image to each of the eyes corresponding to that which would be seen if viewing a real world scene. The brain again fuses the stereo pair to give the appearance of depth in the image.

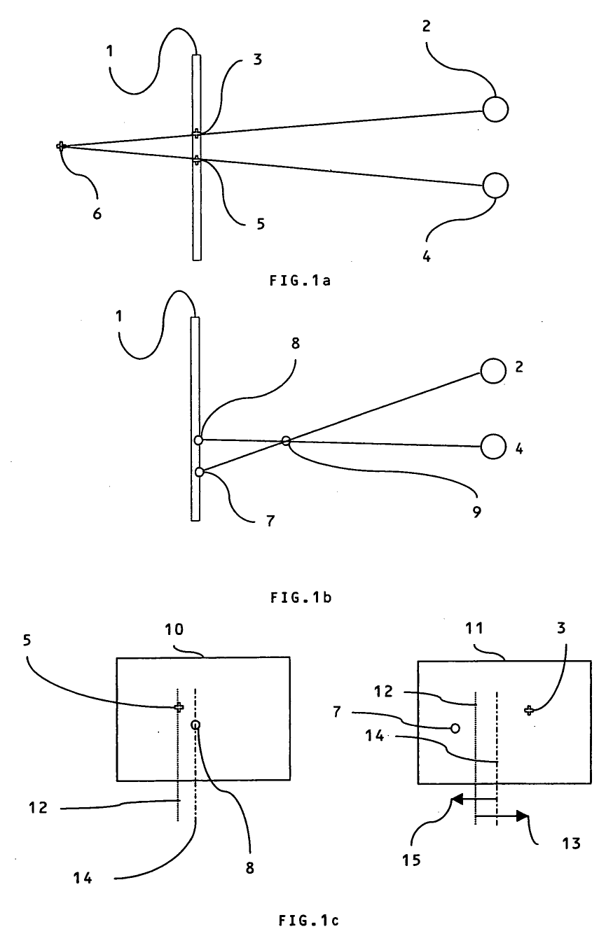

FIG. 1a shows in plan view a display surface in a display plane 1. A right eye 2 views a right eye homologous image point 3 on the display plane and a left eye 4 views a left eye homologous point 5 on the display plane to produce an apparent image point 6 perceived by the user behind the screen plane.

FIG. 1b shows in plan view a display surface in a display plane 1. A right eye 2 views a right eye homologous image point 7 on the display plane and a left eye 4 views a left eye homologous point 8 on the display plane to produce an apparent image point 9 in front of the screen plane.

FIG. 1c shows the appearance of the left eye image 10 and right eye image 11. The homologous point 5 in the left eye image 10 is positioned on a reference line 12. The corresponding homologous point 3 in the right eye image 11 is at a different relative position 3 with respect to the reference line 12. The separation 13 of the point 3 from the reference line 12 is called the disparity and in this case is a positive disparity for points, which will lie behind the screen plane.

For a generalised point in the scene there is a corresponding point in each image of the stereo pair as shown in FIG. 1a. These points are termed the homologous points. The relative separation of the homologous points between the two images is termed the disparity; points with zero disparity correspond to points at the depth plane of the display. FIG. 1b shows that points with uncrossed disparity appear behind the display and FIG. 1c shows that points with crossed disparity appear in front of the display. The magnitude of the separation of the homologous points, the distance to the observer, and the observer's interocular separation gives the amount of depth perceived on the display.

Stereoscopic type displays are well known in the prior art and refer to displays in which some kind of viewing aid is worn by the user to substantially separate the views sent to the left and right eyes. For example, the viewing aid may be colour filters in which the images are colour coded (e.g. red and green); polarising glasses in which the images are encoded in orthogonal polarisation states; or shutter glasses in which the views are encoded as a temporal sequence of images in synchronisation with the opening of the shutters of the glasses.

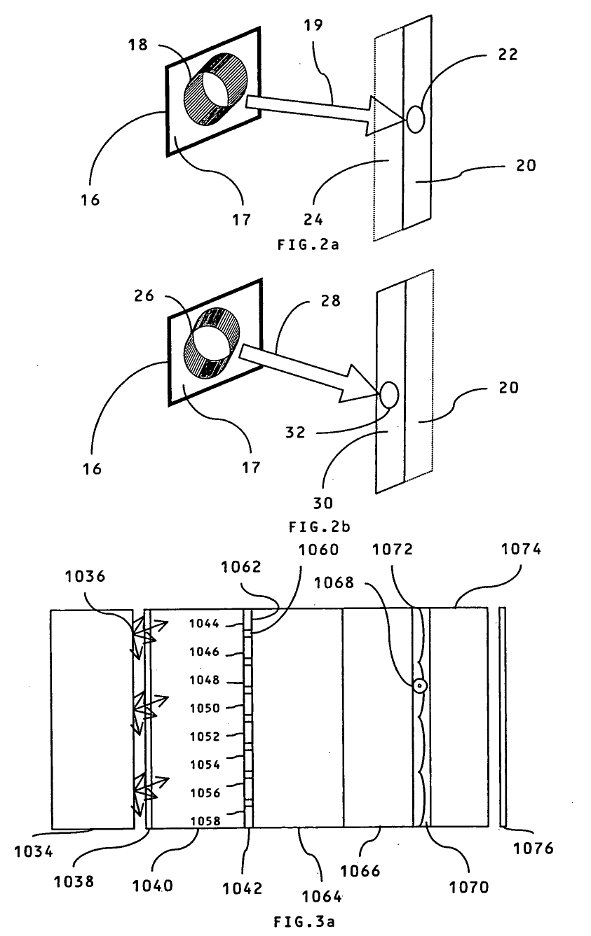

Autostereoscopic displays operate without viewing aids worn by the observer. In autostereoscopic displays, each of the views can be seen from a limited region in space as illustrated in FIG. 2.

FIG. 2a shows a display device 16 with an attached parallax optical element 17. The display device produces a right eye image 18 for the right eye channel. The parallax optical element 17 directs light in a direction shown by the arrow 19 to produce a right eye viewing window 20 in the region in front of the display. An observer places their right eye 22 at the position of the window 20. The position of the left eye-viewing window 24 is shown for reference.

FIG. 2b shows the left eye optical system. The display device 16 produces a left eye image 26 for the left eye channel. The parallax optical element 17 directs light in a direction shown by the arrow 28 to produce a left eye viewing window 30 in the region in front of the display. An observer places their left eye 32 at the position of the window 30. The position of the right eye viewing window 20 is shown for reference.

The system comprises a display and an optical steering mechanism. The light from the left image is sent to a limited region in front of the display, referred to as the viewing window. If an eye is placed at the position of the viewing window then the observer sees the appropriate image across the whole of the display. Similarly the optical system sends the light intended for the right image to a separate window. If the observer places their right eye in that window then the right eye image will be seen across the whole of the display. Generally, the light from either image may be considered to have been optically steered (i.e. directed) into a respective directional distribution.

The optical system serves to generate a directional distribution of the illumination at a window plane at a defined distance from the display. The variation in intensity across the window plane of a display constitutes one tangible form of a directional distribution of the light.

The respective images are displayed at the display plane, and observed by an observer at or near the window plane. The variation in intensity across the window plane is not defined by the variation in intensity across the image; however the image seen by an observer at the window plane may be referred to as the image at the viewing window for ease of explanation.

In this application the term “SLM” (Spatial Light Modulator) is used to include devices which modulate the transmitted or reflected intensity of an external light source, examples of which include Liquid Crystal Displays, and also devices which generate light themselves, examples of which include Electroluminescent displays.

In this application the term “3D” is used to refer to a stereoscopic or autostereoscopic image in which different images are presented to each eye resulting in the sensation of depth being created in the brain. This should be understood to be distinct from “3D graphics” in which a 3D object is rendered on a 2D dimensional display and each eye sees the exact same image

One type of prior art switchable 2D/3D display system uses a switchable backlight unit in order to achieve switching between different directional distributions as described in Proc.SPIE vol. 1915 Stereoscopic Displays and Applications IV(1993) pp 177-186, “Developments in Autostereoscopic Technology at Dimension Technologies Inc.”, 1993. In a first mode, the light distribution from the backlight is substantially uniform and a 2D directional distribution from the display is generated. In a second display mode, light lines are produced by the backlight. These light lines are modulated by LCD pixels so that the windows of an autostereoscopic intensity distribution for viewing a 3D image are formed. The switching could, for example, be accomplished by means of a switchable diffuser element, controlled by a voltage applied across the diffuser. Such diffusers are well known in the prior art.

FIG. 4 shows in frontal view a subsection of the display area 1080 of a prior art LCD pixel plane 1042, on a typical stripe type colour TFT-LCD. The layout comprises an array of pixel apertures 1062, of red pixels in a red pixel column 1082, green pixels in a green pixel column 1084 and blue pixels in a blue pixel column 1086.

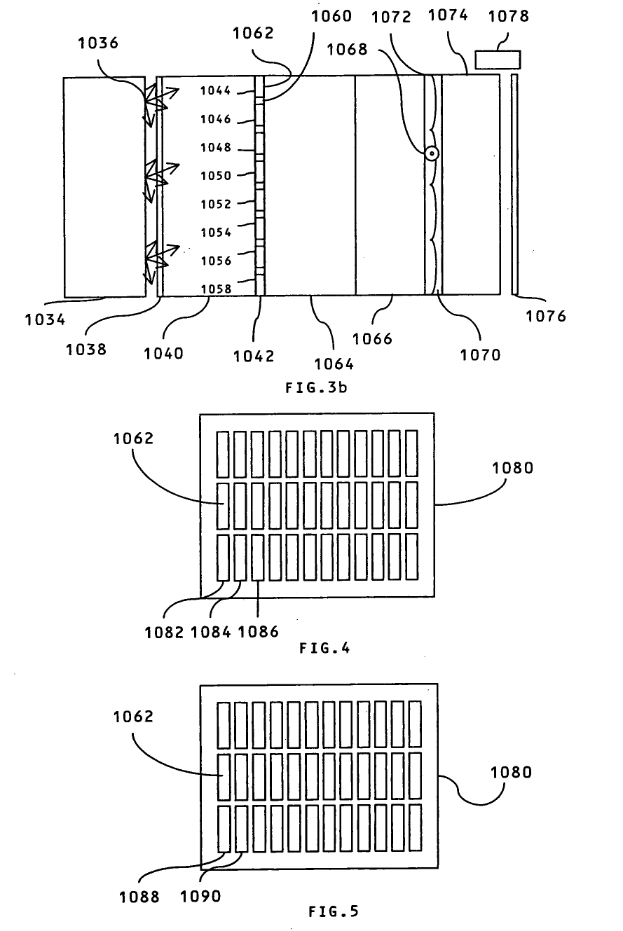

FIG. 5 shows the corresponding position of image data for the same display used in a prior art two view 3D autostereoscopic display of FIG. 3a. It can be seen that the right eye data is placed in right eye view data pixel column 1088 and left eye data is placed on corresponding left eye view data columns 1090. The image data varies down each column to give vertical spatial information.

It is well known to those skilled in the art that more than two view data columns can be used in the display system to allow more than two windows. However, such an arrangement will serve to further reduce the resolution of the image seen by each eye of the observer.

Unrelated to 2D/3D display systems, encryption systems such as public key infrastructure (PKI) are well known in the art.

Generally, as increased functional capability is added to electronic devices, especially portable devices, including capabilities of displays, there is an increased demand for flexibility of use and service that may be provided from remote sources. In the case of switchable 2D/3D displays (and other related switchable displays), a need therefore arises for control methods and apparatus that allow more flexibility both technically and commercially for users of the devices and providers of services and data to the devices or their users.

The present inventors have realised there is a particular need for control methods and apparatus that allow flexibility between display of 2D and 3D images (and other switchable directional distributions), and also for control methods and apparatus that would allow service providers or equipment providers to control potential revenue by means of authorisation procedures.

In a first aspect, the present invention provides a method of driving a display device, where the display device is switchable between at least two light output directional distributions, the method comprising: for an image defined according to the first light output directional distribution, but not authorised or otherwise indicated to be correctly displayed, with the display device set to the second directional distribution, driving the display device so as to replicate the first light output distribution whilst being switched to the second light output directional distribution.

Preferably the first directional distribution comprises providing a single image at a viewing plane formed by all the pixels, and the second directional distribution comprises providing a plurality of images at the viewing plane. Preferably the single image forms a 2D image and the plural images form a 3D autostereoscopic image. Preferably, when driving the display device so as to replicate the first light output distribution whilst being switched to the second light output directional distribution, each of the plural images are arranged to show the same image as each other such that the combined effect is a single image forming a 2D image.

In a further aspect the present invention provides:

a switchable 2D to 3D display apparatus comprising:
an autostereoscopic display apparatus comprising at least:
a spatial light modulator;
an optical directional distribution switching apparatus;
an optical directional distribution sensing apparatus;
an image signal receiving apparatus;
an authorisation receiving apparatus;
a control apparatus;
an image interlacing apparatus arranged to present data on the SLM;

arranged to provide:
in a first operational mode a full resolution 2D image;
in a second operational mode a 3D image;

where in the first operational mode:
the output directional distribution of the optical directional distribution switching apparatus detected by the sensing apparatus is substantially the same as the input optical directional distribution,
the image signal receiving apparatus is arranged to detect the presence of a full resolution 2D image;
the image interlacing apparatus is arranged to present a substantially unmodified 2D image on the spatial light modulator;

and in the second operational mode:
the output directional distribution of the optical directional distribution switching apparatus detected by the sensing apparatus is different to the input optical directional distribution,
   such that an intensity distribution appropriate for a 3D image is seen at the window plane of the display;
the image signal receiving apparatus is arranged to detect the presence of a 3D image pair;
the authorisation receiving apparatus is arranged to detect the presence of an authorisation;
the image interlacing apparatus is arranged to interlace the 3D image pair for presentation on the spatial light modulator such that each view data column contains the respective view data for each view.

Preferably, the apparatus further provides an additional third operational mode which presents a reduced resolution 2D image, where in the third operational mode:
the output directional distribution of the optical directional distribution switching apparatus detected by the sensing apparatus is different to the input directional distribution,
such that an intensity distribution appropriate for a 3D image is seen at the window plane of the display;
the software key receiving apparatus is arranged to detect the absence of an authorisation key;
the image interlacing apparatus is arranged to interlace image data on to the SLM such that the image data is substantially the same for each view data column within each group of view data columns (so a 2D image is seen);

Preferably, in the case of any of the above aspects, the following may additionally be the case:

The autostereoscopic display apparatus may be a spatially multiplexed type.

The optical directional distribution sensing element may determine any one of the following:
the orientation of a polarisation modifying element
the electric field across an electronic polarisation switching device;
the output angular light distribution.

The image signal receiving apparatus may:

determine the type of image received, for example by determining whether an interlaced image has been received, by for example:
measuring the average horizontal pixel-pixel intensity change in the image and compares to a threshold value; or
examining a data flag in the image header file; or
taking an input from a user; or

decrypt the image using an authorisation, where the authorisation may be the same as the authorisation for use of 3D mode.

The authorisation receiving device may:

use an encryption system; where the encryption system may use PKI (public key infrastructure) or other known coding or encryption mechanisms.

The method of identifying individual authorized devices may use:

a built in smart-card and serial number, or may use “cookie” technology.

The encryption system may have “soft” and “hard” modes; where in the soft mode, all those receivers with a suitable decoder may be enabled to see the image, and where in the hard mode, only certain groups of receivers or individual receivers are enabled to see the image.

The authorisation may be:
transmitted from a server device to the display device to permit display of particular images or data; or
transmitted separately from the images; or
embedded within the image data file itself.

The control device may use the information from the directional distribution sensor and authorisation device to determine whether the device should operate in a first, second or third operational mode.

The image interlacing device may be:

implemented in the interface between the graphics controller and the SLM drive electronics; or

implemented in the SLM drive electronics; or

implemented in software in the operating system of a display management system; or

implemented in firmware in the graphics controller; or

additionally adjust the display gamma mapping function between the first mode and the second and third operational modes.

Each group of view data columns may:

contain pixels of the same colour channel; and/or

in the second and third operational mode be displayed with a phase offset between two of the colour channels and the third colour channel.

In a further aspect the present invention provides:

a switchable 2D to 3D display system comprising:
an autostereoscopic display apparatus comprising at least:
a spatial light modulator;
an optical directional distribution switching apparatus;
an optical directional distribution sensing apparatus;
an image signal receiving apparatus;
a software key receiving apparatus;
an image interlacing apparatus arranged to present data on the SLM in respective view data columns;
   arranged to provide:
in a first mode a full resolution 2D image;
in a second mode a reduced resolution 3D image;
in a third mode a warning image;
   where
in the first mode:
the output directional distribution of the optical directional distribution switching apparatus detected by the sensing apparatus is substantially the same as the input directional distribution,
such that an intensity distribution appropriate to a 2D image is seen at the window plane of the display;
the image signal receiving apparatus is arranged to detect the presence of a full resolution 2D image;
the image interlacing apparatus is arranged to present the substantially unmodified 2D image on the spatial light modulator;
in the second mode:
the output directional distribution of the optical directional distribution switching apparatus detected by the sensing apparatus is different to the input directional distribution,
such that an intensity distribution appropriate to a 3D image is seen at the window plane of the display;
the image signal receiving apparatus is arranged to detect the presence of a 3D image pair;
the software key receiving apparatus is arranged to detect the presence of an authorisation key;
the image interlacing apparatus is arranged to interlace the 3D image pair for presentation on the spatial light modulator such that each view data column contains the respective view data for each view;
in the third mode:
In the case of the conditions for the first or second modes not being satisfied a warning image is displayed on the screen.

Preferably the warning image is one of the following:
a pre-defined warning message
a uniformly coloured screen
a black or a white screen
an image such that in combination with the parallax optic, the view data in each view data column is different from the corresponding 3D data.

Further aspects of the invention are as claimed in the appended claims.

In further aspects the present invention provides computer programs executable to implement methods in accordance with the invention, storage media storing such programs and computer apparatus programmed to implement methods in accordance with the invention.

Different features of the invention may tend to provide the following advantages singly or in any combination:
the apparatus ensures that 3D images cannot be seen unless an authorisation has been received, irrespective of the directional distribution setting of the display;
it can prevent the use of 3D data not appropriately authorised for use on the display, even if it has been designed to reproduce the correct pixel map on the SLM for display of 3D images;
the standard 2D image infrastructure may be unmodified by the invention, therefore all 2D images and applications function as normal and the system is backwards compatible and does not require considerable investment in updating of existing equipment or software;
a useful 2D display can be seen for unauthorised 3D image data when in the autostereoscopic directional distribution setting of the display;
the apparatus is compatible with a wide range of 2D and 3D image data formats, so that it is not restricted to particular forms of data;
the same pixel mapping vectors can be used for a range of different image inputs, so that the pixel mapping can be achieved with a single mapping module, irrespective of the image content;
a low cost addition to the driving system can be made which may be independent of the details of operating system or panel drive electronics, and thus conveniently added to a wide range of different display platforms and panel driving schemes;
the apparatus is compatible with low cost manual reconfiguration of the display unit between its directional and non directional modes;
the apparatus may be used with displays electronically reconfigurable between directional and non-directional modes;
in electronically switchable displays, the 3D authorisation and mode switching can be remotely set by the server;
the server may be remotely located and may also provide the image data;
optional image pixel mapping vectors can be used for different image formats, while using the same SLM pixel mapping vectors, thus reducing the cost of the control electronics in the device;
the apparatus may use conventional encryption schemes; the same encryption scheme may be used to authorise both decryption of images and use of 3D images.

Embodiments of the present invention will now be described, by way of example only, with reference to the accompanying drawings, in which:

FIG. 1a shows the generation of apparent depth in a 3D display for an object behind the screen plane;

FIG. 1b shows the generation of apparent depth in a 3D display for an object in front of the screen plane;

FIG. 1c shows the position of the corresponding homologous points on each image of a stereo pair of images;

FIG. 2a shows schematically the formation of the right eye viewing window in front of an autostereoscopic 3D display;

FIG. 2b shows schematically the formation of the left eye viewing window in front of an autostereoscopic 3D display;

FIG. 3a shows a switchable 2D/3D system;

FIG. 3b shows a switchable 2D/3D system with a polarising sensing device;

FIG. 4 shows the prior art configuration of pixels in a stripe type liquid crystal display panel;

FIG. 5 shows an arrangement of data on a spatial light modulator used in a two view autostereoscopic display system;

FIG. 6 is a block diagram showing functional modules of a display device;

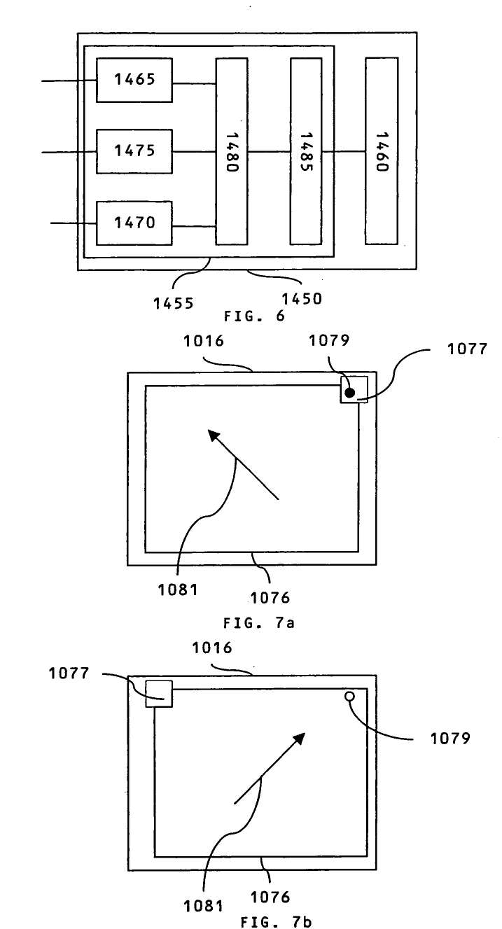

FIG. 7a shows one implementation of a directional distribution sensing element in a first orientation;

FIG. 7b shows one implementation of a directional distribution sensing element in a second orientation;

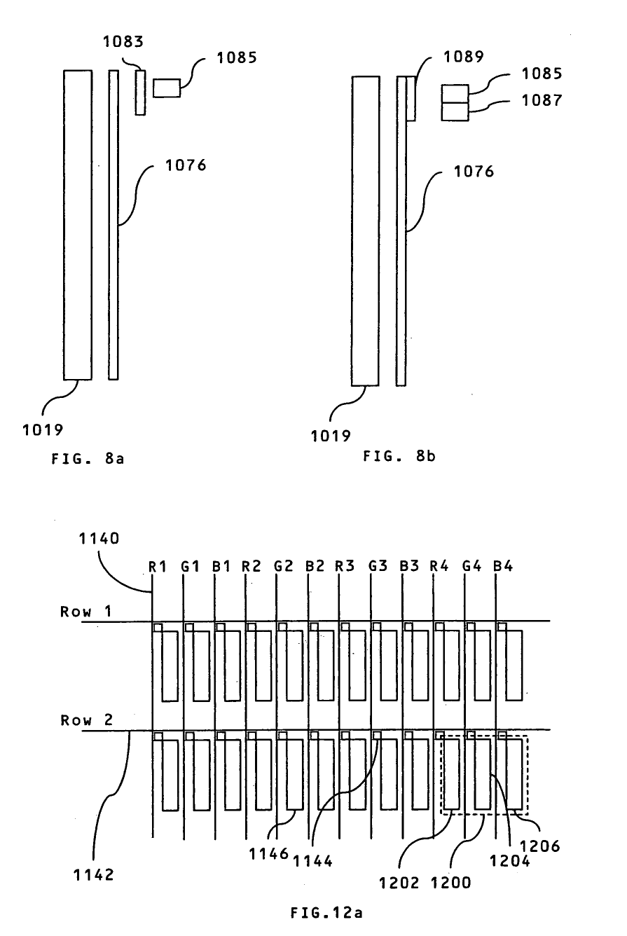

FIG. 8a shows another implementation of the directional distribution sensing element;

FIG. 8b shows a further implementation of a directional distribution sensing element;

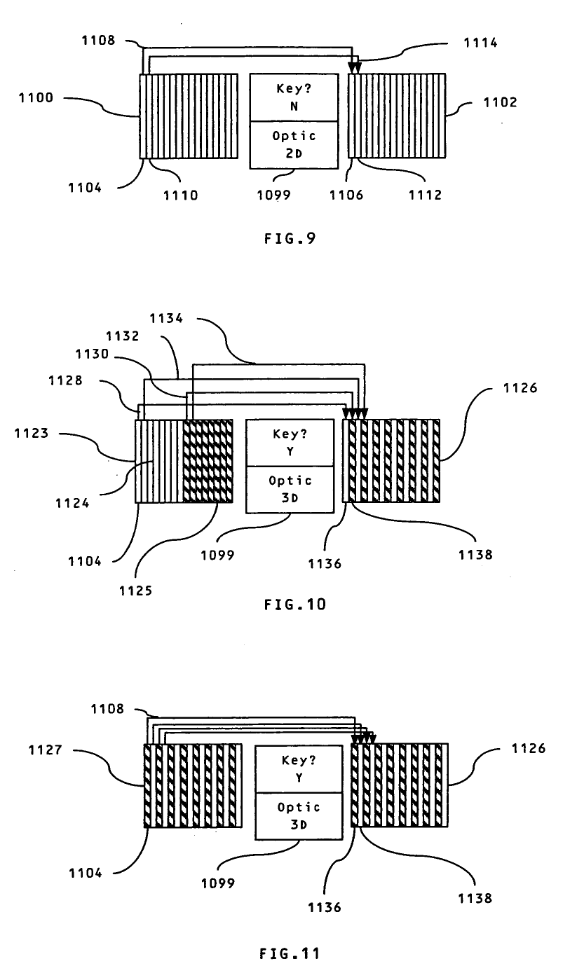

FIG. 9 shows the mapping of image data to the SLM in a first operational mode of an embodiment of the invention;

FIG. 10 shows the mapping of image data to the SLM in a second operational mode of an embodiment of the invention;

FIG. 11 shows a further option for the mapping of image data to the SLM in a second operational mode of an embodiment of the invention;

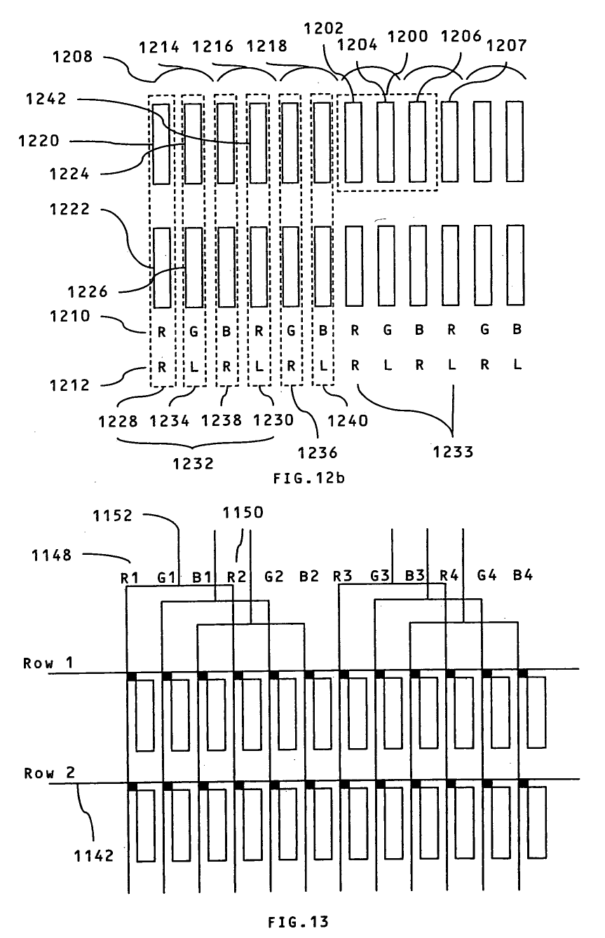

FIG. 12a shows a schematic illustration of the layout of electrodes and transistors in a typical TFT-LCD panel;

FIG. 12b shows the corresponding lens position and pixel and view data on the panel of FIG. 12a.

FIG. 13 shows one apparatus that achieves the SLM data output of a third operational mode of an embodiment of the invention;

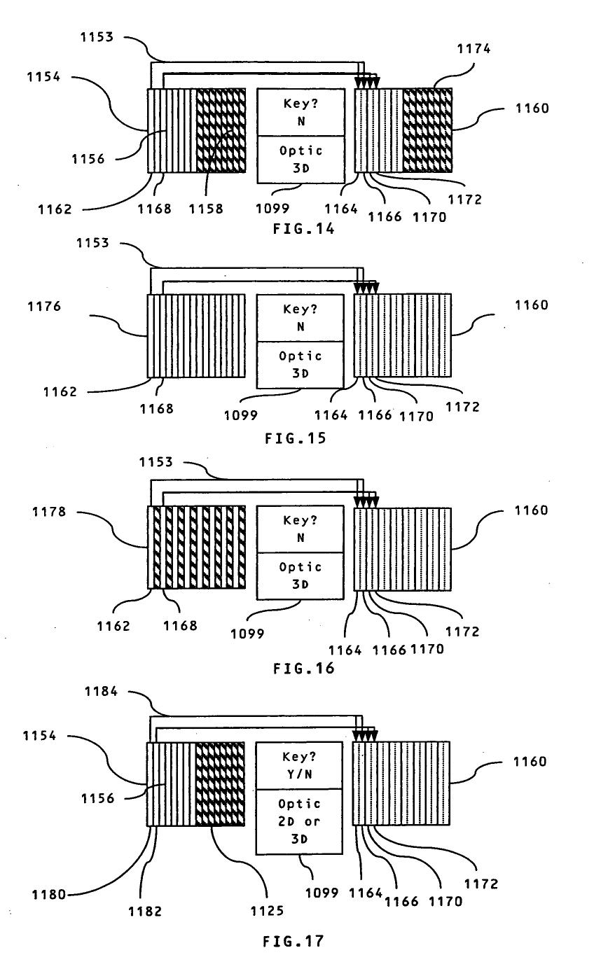

FIG. 14 shows mapping of image data from a side-by-side 3D image to the SLM in the third operational mode;

FIG. 15 shows another mapping of image data from a 2D image to the SLM in the third operational mode;

FIG. 16 shows another mapping of image data from a side-by-side 3D image to the SLM in the third operational mode;

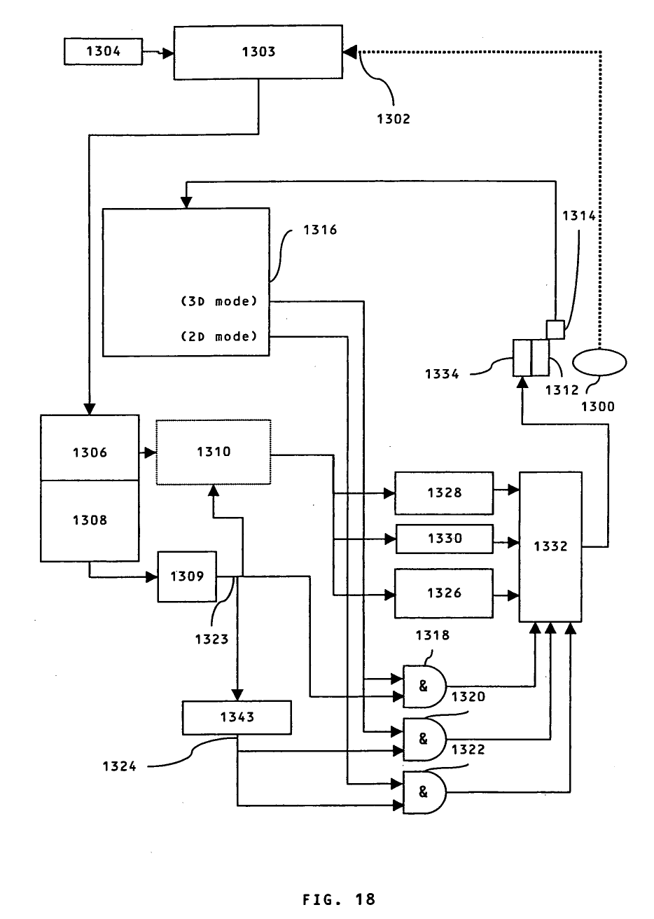

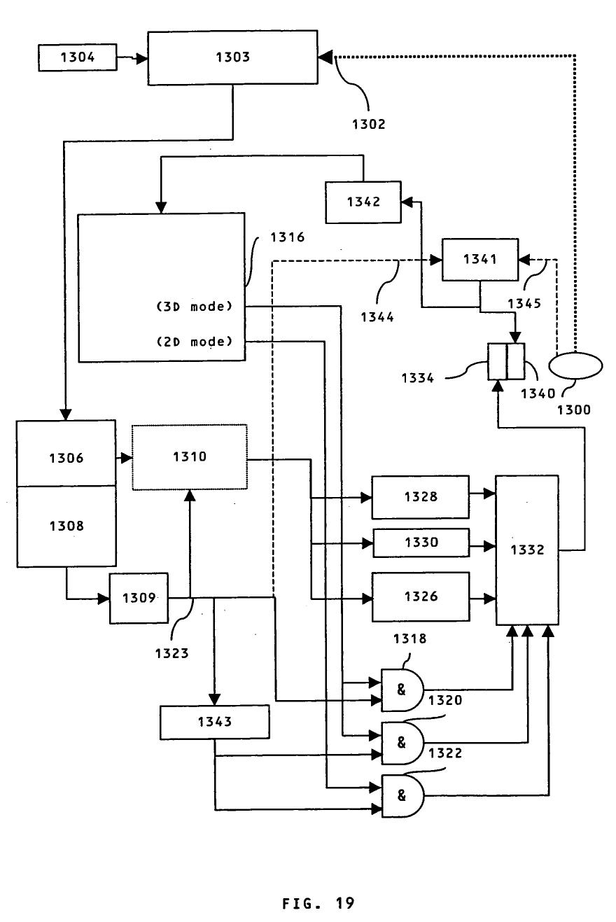

FIG. 17 shows an optional mapping function in the third operational mode;

FIG. 18 shows a control system for a mechanically reconfigurable polarisation device;

FIG. 19 shows a control system for an electronically reconfigurable polarisation device;

FIG. 20 shows an example of an interlacing device to allow switching between data for different operational modes;

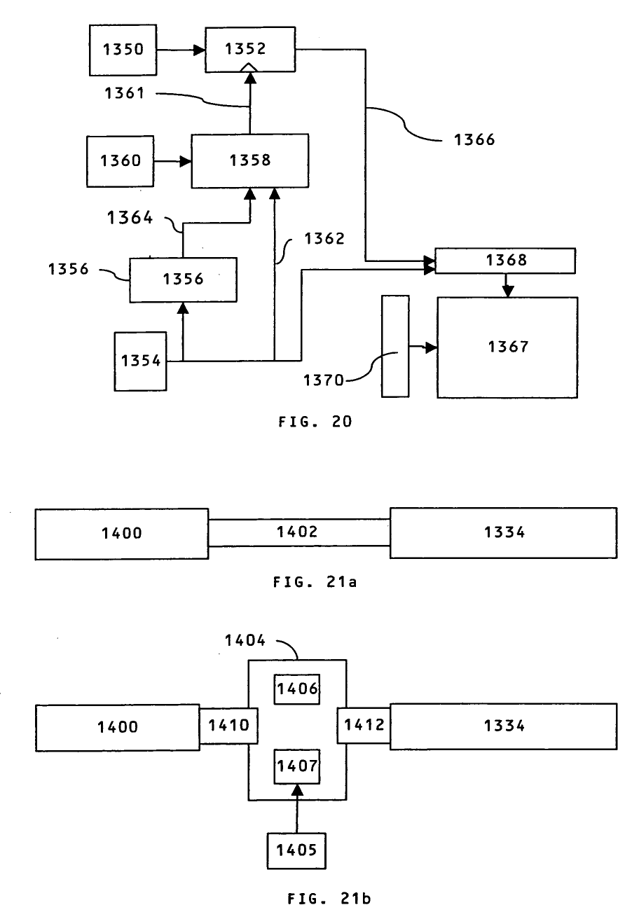

FIG. 21a shows an example of the connection between an SLM and a controller;

FIG. 21b shows an example of how connection between an SLM and a controller may be modified;

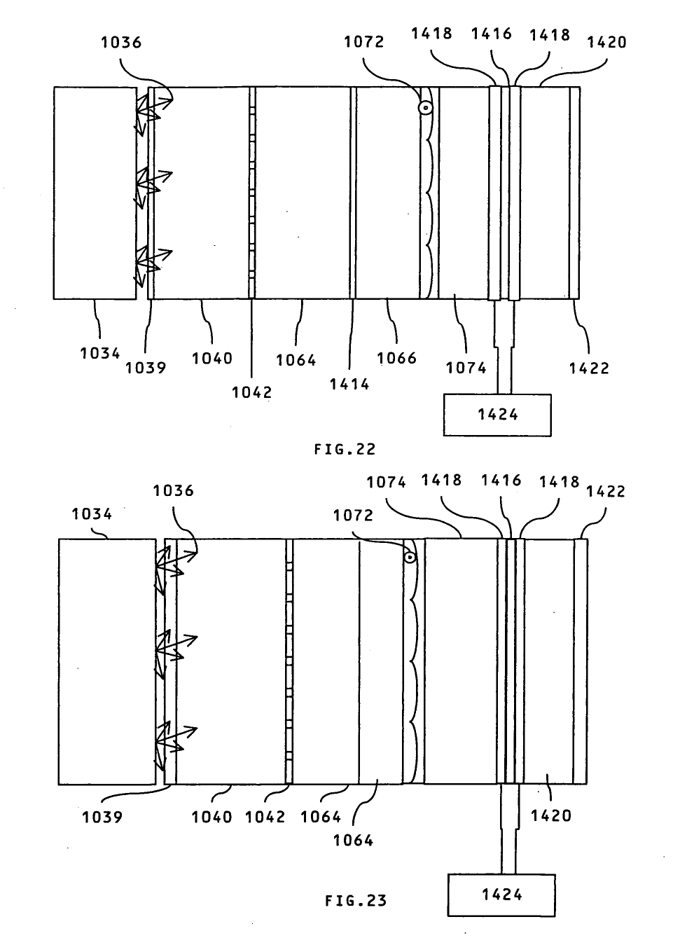

FIG. 22 shows a 3D autostereoscopic display in which the directional distribution is switched by means of an electronically controlled polarisation switching element;

FIG. 23 shows a further 3D autostereoscopic display in which the directional distribution is switched by means of an electronically controlled polarisation switching element between a lens array and an output polariser;

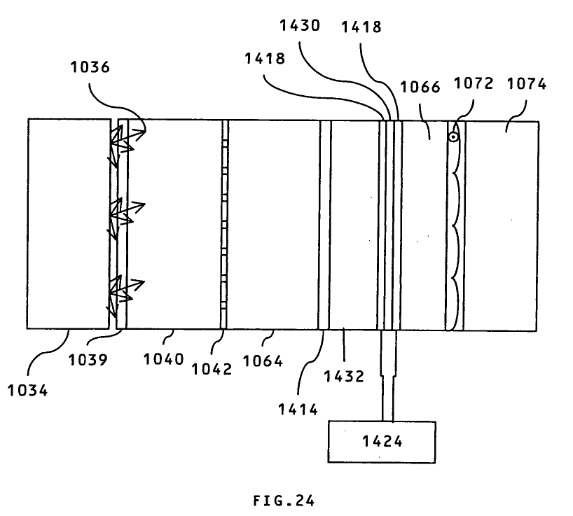

FIG. 24 shows a further 3D autostereoscopic display in which the directional distribution is switched by means of an electronically controlled polarisation switching element between an output polariser and a lens array.

Before describing the present embodiments, a type of 2D/3D switchable directional display device which is particularly suited for implementing the present invention will first be described with reference to FIG. 3a. FIG. 3a shows one type of switchable directional display, as described in co-pending applications British Application No. 0119176.6 and International Application No. PCT/GB02/003513 which are incorporated herein by reference. A backlight 1034 produces an optical output 1036 which is incident on an input linear polariser 1038, and a LCD TFT substrate 1040. The light passes through the pixel plane 1042 comprising an array of LCD pixels 1044-1058. Each pixel comprises a separate region of addressable liquid crystal material, a colour filter and is surrounded by a black mask 1060 to form a pixel aperture 1062. The light then passes through the LCD counter substrate 1064 and through a carrier substrate 1066 to fall on a birefringent microlens 1072 comprising a layer of birefringent material 1068 and an isotropic lens microstructure 1070. The light then passes through a lens substrate 1074 and a polarisation modifying device 1076.

The polarisation modifying device 1076 may be embodied as a linear polariser. In a 2D mode of operation, the transmission axis of the polariser 1076 is aligned to the slow axis of the birefringent material 1068 so that the lenses are index matched to the isotropic lens microstructure 1070, and have no optical effect. Thus the directional distribution of the input light is substantially unmodified.

In a 3D mode of operation the polariser 1076 is aligned with the fast axis of the birefringent material 1068, so that a lens is formed, and the directional distribution of the light outputted from the display is modified to generate viewing windows 20,30.

Further details, and variations, of such devices to which the present invention may be applied are described in co-pending British Application No. 0119176.6 and International Application No. PCT/GB02/03513 which are incorporated herein by reference

FIG. 6 is a block diagram showing functional modules of a display device 1450 in which a first exemplary embodiment of the invention is implemented. The display device 1450 comprises control apparatus 1455 coupled to a spatial light modulator (SLM) 1460 as shown. The control apparatus 1455 itself comprises a display mode module 1465, an image data module 1470, and an authorisation module 1475, each of which are arranged to individually receive external inputs, and all of which are additionally coupled to a controller 1480, which is itself coupled to a driver module 1485, whose output provides the coupling with the SLM 1460.

The SLM 1460 is a spatially multiplexed 2D/3D autostereoscopic display, and is shown in more detail in FIG. 3b. The SLM 1460 is the same as that described above with reference to FIG. 3a, and the same reference numerals are used for the same parts, except that SLM 1460 further comprises a polarising sensing device (or other means) 1078.

As with the device shown in FIG. 3a, the SLM 1460 provides two display modes. In a first display mode, the polariser 1076 is placed a first orientation, such that the birefringent microlens 1072 has no effect, and a 2D image is thus displayed. The pixels are distributed as shown in FIG. 4 for example.

In a second display mode, the polariser 1076 is placed in a second orientation such that the birefringent microlens 1072 does have an effect, converting the spatial distribution of image data in to an angular distribution such that an observer at the window plane sees a stereoscopic, i.e. 3D image (as explained in more detail in GB 0119176.6). The pixels are distributed as shown in FIG. 5 for example.

The polariser sensing device 1078 serves to sense the orientation of the polariser 1076, and thus the directional distribution of the optical output can be monitored, i.e. whether the SLM is operating in a first display mode or a second display mode. One example of such a device is shown in FIG. 7a. A reconfigurable manual polariser 1076 has a notch 1077 cut in one corner, which is aligned with a microswitch 1079. In the first orientation, the microswitch is released and the transmission axis of the polariser is at −45 degrees, causing a 2D directional distribution from the display. To convert to a 3D directional distribution, the polariser is removed, rotated and re-aligned with the display. This causes the microswitch 1079 to be depressed as shown in FIG. 7b.

Another example of a directional distribution sensing device is shown in FIG. 8a. In this case, a photodetector 1085 and polariser 1083 are configured in front of the display 1019 so as to measure the polarisation of the output light from the display. When the polariser 1076 is in one orientation, the detector polariser 1083 is aligned and light is transmitted to the detector 1085. When the polariser 1076 is rotated, then the light in the photodetector is extinguished. Thus the photodetector can be used to sense the polariser 1076 orientation, and thus the directional distribution produced by the display 1019.

Another directional distribution-setting sensing-device is shown in FIG. 8b and may comprise a detector 1085 and a light source 1087 and may co-operate with a reflective or absorptive feature 1089 added to part of the polariser 1076, or added to the support frame of the polariser (not shown). The apparatus may incorporate similar arrangements to determine the polariser is fully inserted. Such sensors and switches are well known for example in the art of photocopier design where they are used to detect the presence or absence of paper.

In other embodiments, instead of being implemented as a repositionable polariser 1076, the polarisation switching component can be an electronic polarisation modifying device in combination with an electrical switch (as explained in more detail in GB 0119176.6). In this case, a sensor detecting the voltage or other electrical parameter across the electronic polarisation modifying device may be used as the directional distribution sensing device.

In this embodiment the control apparatus 1455 is implemented in integrated component form. However, in other embodiments this may be realised in discrete form, or a mixture of integrated components and discrete components, or indeed in any other suitable form. Also, any one, any combination, or each of the display mode module 1465, the image data module 1470, the authorisation module 1475, the controller 1480 and the driver module 1485, or the processes carried out by them, may be implemented by one or more processors of a computer apparatus executing a computer program of processor-implementable instructions. The computer program may be stored on a suitable storage medium, such as computer memory, hard disk, floppy disk, ROM, PROM, optical disk etc.

In this embodiment the image data module 1470 serves as an image receiving device, and receives a digital image at the display system locally or from a location, which may be for example a remotely located telecommunications handset service provider. However, in other embodiments a separate module may receive or load image data, and then only the other processes to be described below are implemented by the image data module 1470.

Preferably the image data module 1470 is adapted to decrypt images if they have been encrypted.

The image data module 1470 may be required to determine automatically the type of image downloaded, particularly for authorised 3D images. This may be by reference to stored data specifying whether the image is a 3D image or stored data specifying whether the image is authorised for display in 3D. This can be accomplished for example by:
a software flag being set in the header of the image file;
the observer selecting in a software menu that the image is 2D;
means of automatic identification of the image as not consisting of data likely to be that of interlaced stripes.

The authorisation module 1475 determines whether the user has been authorised by the service provider to display a 3D image. The authorisation may be obtained by for example a transmitted authorisation code in combination with a smart-card at the user's device, and may additionally use encrypted data.

Optionally the authorisation may take the form of communicating the use of the device such as the time or the number of images viewed in 3D mode to a payment system.

The authorisation may use whatever mechanisms or arrangements that are in general use for authorisation or payment for services on mobile devices.

The display mode module 1465 determines whether the display is switched to the first display mode (2D) or the second display mode (3D). In this embodiment this simply entails receiving this indication from the directional distribution sensing device described above. In other embodiments there may be a direct user input, or menu selection, by which the user can input which mode he has selected (possibly in the case of a simple mechanical switching arrangement) and this may feed directly in to the display mode module 1465.

The controller 1480 uses the inputs from the display mode module 1465, the image data module 1470 and the authorisation module 1475 to determine the appropriate mode of operation of the switchable 2D/3D display. The controller 1480 then controls the driver module 1485 appropriately such that the driver module provides the required driving output to the SLM 1460, i.e. the driver module 1485, which in this example is an image interlacing module or device, uses an instruction from the controller 1480 to generate the appropriate interlaced image data for the SLM 1460.

In the standard configuration as shown in FIG. 12a for a typical TFT-LCD, the pixels are driven by column electrodes 1140 carrying grey level data and row electrodes 1142 carrying the gate voltage for the pixel transistors 1144 at the pixel 1146. Each 2D colour pixel 1200 is made up of a red pixel 1202, a green pixel 1204, and a blue pixel 1206.

FIG. 12b shows the same structure, but with the drive electronics not shown. The relative position of the lenses of the lens array 1208 is marked to show which pixels fall under which lens in a two view display. As can be seen, adjacent pixels constitute different view pixel data. This is indicated in 1210 and 1212, which show the respective colour and view data for each column of pixels.

Thus a correctly positioned observer looking at the display will see in their right eye (across substantially the whole of the aperture of the lens 1214) the grey level corresponding to pixel 1220 in the first row, the grey level corresponding to the pixel 1222 in the second row and so on. In their left eye, they will see the grey level corresponding to pixels 1224 and 1226 in first and second rows respectively.

The pixels 1220, 1222 and those below them constitute the first red view data column 1228, which contains right eye data. Correspondingly, the pixels in column 1230 contain red left eye data and are the second red view data column. Together, 1228 and 1230 constitute the first group of red view data columns 1232 and 1233 the second group of red view data columns.

The corresponding first group of green data columns comprises columns 1234 and 1236. Notice that the phase of the pixels is reversed, such that the left eye pixels are under lens 1214 while the right eye pixels are under lens 1218. However, the left and right eye images remain individually interlaced within each colour pixel array. The blue pixel columns 1238, 1240 in this example have the same phase as the red pixels 1228, 1230.

In the 3D mode of operation the view data columns contain different information corresponding to the homologous images.

The image interlacing device may also use a passive matrix SLM. It may also use SLMs such as electroluminescent or polymer LED SLMs . The SLM may display grey level data in whole or in part by the techniques of frame or pulse width modulation as are well known.

The display device 1450 provides three operational modes (note these should not be confused with the first and second display modes which as described above are the two directional distribution modes that the SLM can be switched between).

First Operational Mode

The first operational mode is a full resolution 2D mode in which an authorisation is not required and the output directional distribution is substantially the same as the input directional distribution, i.e. the SLM operates in the first display mode.

As shown in FIG. 9, a 2D image 1100 is downloaded to a display device incorporating a 2D/3D switchable display of the spatially multiplexed type. FIG. 9 shows the mapping of the 2D data on to the display once the settings 1099 of the authorisation key and directional distribution are determined by the display mode module 1465 and authorisation module 1475 of the control device 1455.

The image data 1100 is mapped on to the display area 1102 by a pixel mapping vector 1108. Thus the first column 1104 comprises a column of image pixels and is mapped on to the display 1102 as a display pixel column 1106, by the vector 1108 that shows the action of the image interlacing device. Similarly a second image pixel column 1110 is mapped on to a second display pixel column 1112 by a second pixel mapping vector 1114. The process continues so that the image is displayed in the conventional manner.

In this first operational mode, the system will generally not require any monitoring of the encryption status as it is not a variation on the standard use of the display. Thus, an advantage of this embodiment is that encryption data does not have to be added to standard 2D images, and thus the standard 2D infrastructure is unmodified.

Second Operational Mode

In the second operational mode of the invention, an authorisation is detected, a 3D image is downloaded and the output directional distribution is determined to be different to the input directional distribution by the directional distribution sensor. In other embodiments, where authorisation as such is not required, a flag or header content indicating a 3D image may be received and detected instead. In other embodiments, both an authorisation and a flag or header content indicating a 3D image may be received and detected.

The image receiving device (i.e. image data module 1470) determines the type of 3D image format that has been downloaded. This may be for example a side-by-side pair of 2D images 1123 as shown in FIG. 10 which comprises regions of left eye image region 1124 and a right eye image region 1125. Alternatively, the image may be a pre-interlaced image 1127 as shown in FIG. 11.

In the case of the side-by-side images, the data is interlaced as shown in FIG. 10. The image interlacing system (i.e. the driver module 1485) interlaces the images on to the SLM 1126 as shown by pixel vectors 1128-1134. Thus the respective view data columns 1136 and 1138 show the respective left and right eye view data.

In the case of the pre-interlaced image 1127, the image can be treated as a 2D image and mapped 1:1 on to the SLM for example by the pixel mapping vector 1108 as shown in FIG. 11.

The interlacing patterns described show the interlacing for each of the colour planes. The appropriate horizontal phase shifts between the colour planes may be implemented for each colour channel in order to match the output order and timing of the graphics controller system to the data order and timing requirements of the SLM. Such arrangements tend to be specific to each system, but are well understood in the art and are therefore not described further.

Third Operational Mode: Reduced Resolution 2D Images

The third operational mode is a half horizontal resolution 2D mode, and is implemented if an authorisation is not received and the output optical directional distribution of the SLM is detected as different to the input optical directional distribution (i.e. is operating in the second display mode). Use of this third operational mode prevents use of autostereoscopic 3D images on the display without the appropriate authorisation. In other embodiments the third operational mode may serve to prevent the attempted display of images in the second display mode (3D) when both of no appropriate authorisation being received and only 2D images being received occurs.

In the third operational mode the driver module 1485 maps the same image within each group of view data columns of the display. Thus in FIG. 12b, the first group of red data columns 1232 will contain the same image data. Thus pixels 1220 and 1242 will contain the same grey scale information. The pixel data will vary from row to row, to preserve the vertical image data content, and the pixel data will vary from group to group to preserve the lateral resolution of the final image. Similarly, the pixels 1202 and 1207 of the second group of red view data columns will contain the same grey scale information.

As described previously, the details of the interlacing will depend on the specific addressing scheme used by the panel, but in the case of a stripe type TFT-LCD, the phase of at least one of the colour channels is adjusted in order to achieve the correct separation of views.

Thus, when the authorisation code detection system (i.e. authorisation module 1475) finds that the incorrect authorisation data is present and the directional distribution sensing device determines that the display is operating in the 3D mode, each group of view data columns is set to contain the same data.

FIG. 13 schematically shows one example of a modified configuration of the SLM addressing of FIG. 12a. As described, adjacent view data columns are given the same view data in each row. So for example the first two red columns 1148, 1150 are driven by a common signal 1152. The function of the link 1152 may be established by a modification to the drive electronics or by a modification to the output drive scheme of a software image interlacer.

FIGS. 14-16 shows the implementation of the pixel mapping vectors 1153 in the third operational mode of the invention, using the example of the red channel. The pixel mapping vectors describe the mapping of the pixels from the image to the spatial light modulator.

In FIG. 14, the side-by side 3D image 1154 comprises a region 1156 of columns containing left eye image data and regions 1158 containing right eye image data. The data is mapped by the pixel vectors 1153 to the SLM 1160 such that the first image data column 1162 is mapped to the first group of view data columns 1164,1166, the third image data column 1168 is mapped to the second group of view data columns 1170, 1172 and so on. As can be seen, the right side 1174 of the SLM 1160 will contain the right eye image data in this example. The process is similar for blue and green image data, with the appropriate phase change of data incorporated as described above.

In FIG. 15, the same pixel mapping vectors 1153 are used as for the example in FIG. 14. However, the 2D image 1176 is mapped to the SLM 1160 so that the image data is the same on the view data columns 1164, 1166. In this way, the same electronic or software modules can be advantageously used to configure the image data on to the SLM for this kind of image in the third operational mode of operation.

In FIG. 16, once more the same pixel vectors 1153 are again used to map the data from a pre-interlaced image to the SLM. In this case, it may be imagined that the user may attempt to circumvent the authorisation system by introducing an image which in combination with a 3D directional distribution of the SLM would give an unauthorised stereoscopic image. However, the pixel mapping as described previously will mean that the original interlacing pattern cannot be preserved on to the SLM. Thus it is not possible to obtain a stereoscopic image without the authorisation, as the absence of the authorisation when the directional distribution sensor indicates that the display is set in a 3D optical mode requires the use of identical view data in each view data column.

Thus, a particular and unexpected advantage of this embodiment is that in the third operational mode, irrespective of the data content of the image, the same pixel mapping vector can be used to map to a 2D image for the observer. Thus, a single data conversion module can be used in this mode, which will function for a range of different images. Thus, the cost of the data conversion system can be minimised.

In the arrangement of FIG. 14, if the side-by-side image 1123 comprises two half-width images then the final image displayed on the SLM will be two side-by-side, horizontally squashed images. In general, it is likely that in the third operational mode of operation, the device will automatically use this kind of pixel mapping vector. However, by means of a software flag in the image data, or by user selection, a second pixel mapping vector can be used. FIG. 17 shows an alternative pixel mapping vector 1184 which may be preferred. In this case, the left homologous image is stretched by the mapping process to give the correct aspect ratio across the display. However, as can be seen, the mapping of the data on to the display is the same as used previously, in which the data in each of the view data columns is kept constant. In this case, pixel column 1180 of the image 1154 is matched to pixel columns 1164 and 1166 while pixel column 1182 is mapped to pixel columns 1170 and 1172.

It can also be seen that the conversion of the data in FIG. 16 can be used in the case of the download of a pre-interlaced image in which the directional distribution of the output is the same as the input. Similarly, the conversion of FIG. 17 can be used in the case of the download of a side-by-side image in which the directional distribution of the output is the same as the input.

System Operation

An example of operation of the system can be seen schematically in FIG. 18. A user 1300 makes a request 1302 to a service provider 1303, which may be remotely located, to download a 3D image. The image data 1304 is downloaded by the service provider 1303 and sent for example in encrypted form to the image receiving device 1306 on the user's handset. In the users handset there may be an authorisation key 1308 which was transmitted by the server or entered in to the users device by another means such as the handset keypad. If the authorisation is authenticated by an authentication apparatus 1309, then a logical ON on signal 1323 is produced and the image may, if required, be decrypted 1310. If the authorisation is not present or not authenticated then a logical OFF on signal 1323 is produced and the image may be passed unmodified through the decryption block 1310.

Meanwhile, the user sets the configuration of the polariser 1312 on the display, which is sensed by the directional distribution sensor 1314. The sensor information is sent to a control device which may include a microcontroller, (not shown), or may comprise logic apparatus 1316, 1318, 1320 and 1332.

If the directional distribution is in the 3D mode, then a logical ON is sent to AND gates 1318 and 1320 from logic apparatus 1316. If the 2D mode directional distribution is present then the logical ON is sent to AND gate 1322. If the image received authorisation and was authenticated, a logical ON on signal 1323 is sent to gate 1318. If the image did not receive correct authorisation then a logical OFF on signal 1323 is generated and then a logical ON on signal 1324 is sent to gate gates 1320 and 1322 by means of an inverter 1343.

The outputs of 1318, 1320 and 1322 are inputted in to a data select device 1332. This is used to select which of the pixel mapping functions 1328, 1330, 1326 are applied to the image data sent to SLM 1334. For mode 1 operation, the image is mapped by mapping vector device 1326 selected by 1322 corresponding to 2D mode. For mode 2 the image is mapped by mapping vector device 1328 selected by 1318 corresponding to authorised 3D mode. For mode 3 the image is mapped by mapping vector device 1330 selected by 1320.

Devices using Electronic Control of Directional Distribution

If the directional distribution modification device is electronically switchable, such as by means of an electronic shutter, then the shutter can be controlled automatically. Shutter refers to an optical element capable of modifying the polarisation state of the output of the display as described in co-pending GB01 19176.6.

The download of a 3D authorisation can also be used to configure the appropriate directional distribution automatically. This is illustrated in FIG. 19 which is similar to FIG. 18 except that the directional distribution switching element 1312 is replaced by an electrically switched element 1340 which is controlled by a electrical driving means 1341. The setting of the electrical driving means may be determined automatically for example by a logical control signal 1344 from the authentication apparatus 1309, or optionally by means of a user set switch 1345. A determining device 1342 is configured to determine the directional distribution from 1340. This may be by means for example of determining the electrical signal across the shutter from device 1341; of sensing the optical throughput of the shutter 1340 (no shown), or by determining the logical input to the device 1341 (not shown).

The electrical switched element 1340 may be a polarisation switching element. In a first mode, the polarisation switching element is arranged to pass light of a first polarisation state with a first directional distribution. In a second mode, the polarisation switching element is arranged to pass light of a second polarisation state with a second directional distribution. The directional distribution may be achieved by means of a birefringent lens for example. Other birefringent elements which are switched by means of passing light of a first or second polarisation include patterned birefringent films arranged to form a switchable parallax barrier.

Alternatively, the switching directional distribution modifying element may be a switchable liquid crystal lens or switchable light lines, well known in the art.

If a 2D page has some authorised 3D images, but also 2D material such as text, then the control of the data to the SLM is correctly handled by the data selector 1332. It may be that the image screen to be displayed is segmented between 2D and 3D regions, while the shutter controlling the directional distribution of the SLM is not segmented. If the shutter element is not segmented then the user may not want the display to automatically switch to 3D mode which it otherwise would do as it contains authorised 3D images. Thus an optional manual control 1345 is provided. The sensing apparatus 1342 in conjunction with the manual control prevents the display of unauthorised images while allowing the user to toggle the display of authorised 3D images between 2D mode and 3D mode.

In this way, when the user attempts to over-ride the electronic shutter controlling the directional distribution control system, it will be possible to ensure that only authorised images are seen on the display.

The server can automatically enable the 3D directional distribution. Such a mechanism is particularly advantageous for example for downloading advertising content that may not be specifically requested by the user.

Embodiment of Image Interlacing Apparatus

Advantageously, in the third operational mode, the data can be set to be the same for each group of view data pixel columns, by selection of different clock signals to the data latch 1352 as illustrated in FIG. 20. The image data 1350 is latched by latch 1352, for each bit of each data channel. The horizontal data clock input 1354 passes through a divide by two module 1356 and is also passed unmodified, to a clock select module 1358. The authorisation signal 1360 determines which of the input clocks is selected to be passed to the latch by the clock select output 1361, whether the clock 1362 for the first operational mode and second operational mode or the clock 1364 for the third operational mode 1364 is set.

The clock data 1361 is then used to trigger the latch 1352 so that the latched data 1366 is transferred to the display pixel array 1367 by means of the column driver 1368 and row driver 1370. Thus in a mode in which all data columns are addressed independently, the full clock rate for clock 1362 is selected and the data is driven at the full clock rate. However, in the third operational mode in which each group of view data columns is to contain the same view data information, the same data is read twice in to the display by using half the clock rate for clock 1364 in order to control the latch.

This circuit may be repeated for each colour channel e.g. R,G,B as required. An appropriate data phase offset may be implemented for each colour channel in order to match the output order and timing of the graphics controller system to the data order and timing requirements of the SLM. Such arrangements tend to be specific to each system, but are understood in the art.

For analogue data, the latch function 1352 may be embodied as a sample and hold circuit with sampling controlled by the clock input.

For digital data, the latch function 1352 may be embodied as a “D type” flip flop for each bit of data.

In a typical display system, the SLM 1334 would be connected to a graphics controller function 1400 by means of a flat multi-conductor cable 1402 as illustrated in FIG. 21a. The invention may be conveniently and cheaply implemented in such systems as illustrated in FIG. 21b. A small additional circuit board 1404 which may be a flexible film on which an authorisation apparatus 1407 receiving an authorisation signal 1405 and further components 1406 and connecting tracks (not shown) are used with multi-conductor connectors 1410 and 1412 to provide the hardware functions of FIGS. 18 or 19. Thus these embodiments may be implemented without requiring significant adjustment of the display or operating system of the typical display device.

In other embodiments either or both of the first and second operational modes may be omitted. For example, in embodiments where the only criteria for display of the 3D images is whether authorisation is received, then there may be no requirement for usual display in 2D of 2D images. In this case, the first operational mode may be omitted. Then, if due to missing authorisation it is desired to allow only 2D to be seen, then the third operational mode may be used. Indeed, even if there is a requirement for display of 2D images, the first operational mode may still be omitted, with the 2D images being shown using the third operational mode, albeit at a cost of reduced resolution.

The following options may be employed in further embodiments.

The authorisation module may use an encryption system. The encryption system may use PKI (public key infrastructure) or other known coding or encryption mechanisms. The method of identifying individual authorized devices may use a built in smart-card and serial number, or may use “cookie” technology as well known in the art of internet technology. The encryption system may have “soft” and “hard” modes; in the “soft” mode, all those receivers with a suitable decoder may be enabled to see the image; in the hard mode, only certain groups of receivers or individual receivers are enabled to see the image.

The authorisation may be transmitted from a server device to the display device to permit display of particular images or data. The authorisation may be transmitted separately from the images or embedded within the image data file itself.

The image interlacing device (i.e. driver module) may be:

implemented in whole or in part in the interface between the graphics controller and the SLM drive electronics;

implemented in whole or in part in the SLM drive electronics;

implemented in whole or in part in software in the operating system of a display management system;

implemented in whole or in part in firmware in the graphics controller;

additionally adjust the display gamma mapping function between the first operational mode and the second and third operational modes.

Each group of view data columns may contain pixels of the same colour channel. Also, each group of view data columns may, in the second and third operational modes, be displayed with a phase offset between two of the colour channels and the third colour channel.

In the case of the conditions for the first or second operational modes not being satisfied, then in the third operational mode a warning image may be displayed on the screen. The warning image may be one of the following:

a pre-defined warning message;

a uniformly coloured screen;

a black or a white screen;

an image such that in combination with the parallax optic, the view data in each view data column is different from the corresponding 3D data.

Further Examples

As an alternative to the switchable directional display illustrated in FIG. 3a, the present invention may be applied to any optical switching apparatus switchable between two display modes. This includes the alternative spatial light modulators disclosed in British Application No. 0119176.6 and International Application No. PCT/GB02/03513. This also includes other display devices and spatial light modulators switchable between 2D and 3D display modes, for example of the known types disclosed in Proc.SPIE vol. 1915, Stereoscopic Displays and Applications IV(1993) pp 177-186, “Developments in Autostereoscopic Technology at Dimension Technologies Inc.”, 1993, acknowledged above; GB-A-2,317,710; GB-2,317,295; EP-A-0,860,807; WO-98/21620; and U.S. Pat. No. 6,061,179 which are all incorporated herein by reference.

In any of the above description it should be understood that part or parts of the display area of SLM may be operated as described in the above embodiments with other parts of the display area remaining substantially unswitched.

The SLM of the invention may include or co-operate with an additional a further device used to indicate the region of best viewing of 3D images. Such devices are described for example in co-pending British Application No. 0119176.6 and International Application No. PCT/GB02/03513 which are incorporated herein by reference.

The invention may be used to regulate and control the viewing of directional images other than 3D images, for example such as those described in co-pending British Application No. 0119176.6 and International Application No. PCT/GB02/03 513 which are incorporated herein by reference.

This includes for example a multi-user display where different viewers see different images due to their different viewing locations.

The directional distribution sensing means may co-operate with the control system of the device to report data to a server on the length of time and or the number of images displayed in any of the modes of operation described, i.e. the optical switching apparatus may be monitored for being in or being switched to the second display mode. Such information may be communicated to a remote entity and/or used for purposes including revenue charging or monitoring purposes.

FIG. 22 shows a further type of switchable directional display, as described in co-pending applications British Application No. 0119176.6 and International Application No. PCT/GB02/003513 which are incorporated herein by reference, in which the directional distribution is switched by means of a switchable polariser element. A backlight 1034 produces an optical output 1036 which is incident on an input polariser 1039 (which may comprise for example a linear polariser or a combination of optical retarders and a linear polariser, as well known in the art), and a LCD substrate 1040. The light passes through the pixel plane 1042 comprising an array of LCD pixels. The light then passes through the LCD counter substrate 1064, an LCD output polariser 1414 (which may comprise for example a linear polariser or a combination of optical retarders and a linear polariser, as well known in the art) and through a carrier substrate 1066 to fall on a birefringent microlens 1072 comprising a layer of birefringent material and an isotropic lens microstructure. The light then passes through a lens substrate 1074 and a polarisation modifying device 1416.

The polarisation modifying device 1416 may be embodied as for example a twisted nematic liquid crystal layer sandwiched between surfaces treated with transparent electrodes and liquid crystal alignment layers 1418 as well known in the art. A sensing device 1424 may be used to monitor the electrical driving of the polarisation switching layer 1416. The second substrate 1420 of the cell 1416, 1418 has a polariser 1422 attached to its second surface.

The polariser 1414 may be a linear polariser with a transmission direction aligned at, for example, 45 degrees to the birefringent optical axis of the microlens 1072. The birefringent axis of the microlens is the direction of the extraordinary axis of the birefringent material used in the birefringent microlens 1072. The polarisation state incident on to the birefringent microlens will resolve on to the two axes of the birefringent material. In a first axis, the refractive index of the birefringent material is substantially index matched to the isotropic index of the birefringent microlens 1072 and so the lens has substantially no imaging function. In a second axis, which may be orthogonal to the first axis, the refractive index of the birefringent material has a different refractive index to the isotropic material and thus the lens has an imaging function.

In a 2D mode of operation, no voltage is applied across the liquid crystal layer 1416, and an incident polarisation state is rotated. In a 3D mode of operation, a voltage is applied across the cell, and the incident polarisation state is substantially unrotated.

If the switch 1416 is set so that the polarisation state transmitted through the polariser 1422 is parallel to the first axis, then the display will have a 2D directional distribution. If the switch 1416 is set so that the polarisation state transmitted through the polariser 1422 is parallel to the second axis, then the display will have an autostereoscopic 3D directional distribution. The sensing device 1424 thus determines the display mode of the optical switching apparatus by determining the electrical driving of the polarising element.

FIG. 23 shows a further type of switchable directional display, as described in co-pending applications British Application No. 0119176.6 and International Application No. PCT/GB02/003513 which are incorporated herein by reference, in which the directional distribution is switched by means of a switchable polariser element. This is similar in structure to the architecture of FIG. 22 except that the polariser 1414 is omitted. Such a device operates is a similar way to the device of FIG. 3a except that the mechanically reconfigurable polariser is replaced by an electrically switched polariser 1416 which may be for example a twisted nematic liquid crystal layer sandwiched between surfaces 1418 comprising transparent electrodes and alignment layers and an absorbing linear polariser 1422.

As described for FIG. 3a, the device may be switched between 2D and 3D directional distributions by selecting the polarisation state that is transmitted by the final polariser 1428. The sensing device 1424 thus determines the display mode of the optical switching apparatus by determining the electrical driving of the polarising element.

FIG. 24 shows a further type of switchable directional display, as described in co-pending applications British Application No. 0119176.6 and International Application No. PCT/GB02/003513 which are incorporated herein by reference, in which the directional distribution is switched by means of a switchable polariser element positioned between a display output polariser and a birefringent microlens array 1072. The output linear polarisation of the display transmitted by polariser 1414 is transmitted though a switch substrate 1432, transparent electrodes and alignment layers 1418 sandwiching a twisted nematic layer 1430, a lens counter substrate 1066, a birefringent microlens 1072 and a lens substrate 1074.

In the 2D mode, the polarisation switch 1430 rotates the incident polarisation so that it is incident on to the ordinary axis of the material in the birefringent microlens. The ordinary index is matched to the index of the isotropic material and thus the lens has no effect. In the 3D mode, an electric field is applied to the liquid crystal layer 1430 so that the polarisation state is not rotated and the light is incident on the extraordinary axis of the birefringent microlens. The lens then has an optical effect which produces the autostereoscopic directional distribution.

The sensing device 1424 thus determines the display mode of the optical switching apparatus by determining the electrical driving of the polarising element.

Each of the example embodiments illustrated in FIGS. 3a, 22, 23 and 24 are suitable for transmissive, reflective or transflective modes of operation in both the 2D and autostereoscopic 3D modes. In reflective mode, backlight 1034 and polariser 1039 may be omitted.

1. A method of driving an optical switching apparatus switchable between a first display mode that provides a common image at each of a plurality of different viewing windows and a second display mode that provides a distinct image at each of the plurality of different viewing windows;
the method comprising:
(i) determining whether the optical switching apparatus is switched to the second display mode;
(ii) determining whether an image to be displayed is not authorised to be displayed with a distinct image at each of the plurality of different viewing windows; and
(iii) responsive to an affirmative determination in both steps (i) and (ii), driving the optical switching apparatus using a driving scheme arranged to display the image such that the distinct images at each of the plural viewing windows in the second display mode are substantially the same as each other.

2. A method according to claim 1, wherein the optical switching apparatus is switchable between the first and second display modes by a polariser being repositioned, and the step of determining that the optical switching apparatus is switched to the second display mode comprises sensing the position of the polariser.

3. A method according to claim 1, wherein the optical switching apparatus is switchable between the first and second display modes by electrical driving of a polarising element, and the step of determining that the optical switching apparatus is switched to the second display mode comprises determining the electrical driving of the polarising element.

4. A method according to claim 1, wherein the second display mode provides a distinct image at each of the plurality of different viewing windows by driving adjacent columns with data from distinct images; and the step of driving the display using a driving scheme arranged to display the image such that the distinct images at each of the plural viewing windows in the second display mode are substantially the same as each other comprises applying the same data from the image to be displayed to adjacent columns.

5. A method according to claim 4, wherein the step of applying the same data from the image to be displayed to adjacent columns comprises:
(iv) latching or sampling the column data; and
(v) controlling the latching or sampling by a clock signal related in frequency and phase to a horizontal clock of the optical switching apparatus.

6. A method according to claim 5, wherein the step of applying the same data from the image to be displayed to adjacent columns further comprises:
(vi) performing steps (iv) and (v) for each colour channel.

7. A method according to claim 1, wherein the step of driving the optical switching apparatus using a driving scheme arranged to display the image such that the distinct images at each of the plural viewing windows in the second display mode are substantially the same as each other is performed for only a portion of a display area of the optical switching apparatus.

8. A method according to claim 1, further comprising receiving the image data of the image to be displayed from a remote source.

9. A method according to claim 1, further comprising monitoring the optical switching apparatus being in or being switched to the second display mode.

10. A method according to claim 9, further comprising communicating, to a remote entity, monitored data related to the optical switching apparatus being in or being switched to the second display mode.

11. A method according to claim 1, wherein the first display mode provides a 2D image and the second display mode provides a 3D autostereoscopic image.

12. A method according to claim 1, wherein the step of determining that an image to be displayed is not authorised to be displayed with a distinct image at each of the plurality of different viewing windows comprises identifying a flag in data associated with the image data.

13. A method according to claim 1, wherein the step of determining that an image to be displayed is not authorised to be displayed with a distinct image at each of the plurality of different viewing windows comprises processing a user input.

14. Control apparatus for controlling driving of an optical switching apparatus switchable between a first display mode that provides a common image at each of a plurality of different viewing windows and a second display mode that provides a distinct image at each of the plurality of different viewing windows;
the control apparatus comprising:
(i) means for determining that the optical switching apparatus is switched to the second display mode;
(ii) means for determining that an image to be displayed is not authorised to be displayed with a distinct image at each of the plurality of different viewing windows; and (iii) means for providing, responsive to affirmative outputs from the means for determining that the optical switching apparatus is switched to the second display mode and the means for determining that an image to be displayed is not authorised to be displayed with a distinct image at each of the plurality of different viewing windows, a driving scheme arranged to display the image such that the distinct images at each of the plural viewing windows in the second display mode are substantially the same as each other.

15. Control apparatus according to claim 14, wherein the optical switching apparatus is switchable between the first and second display modes by a polariser being repositioned, and the means for determining that the optical switching apparatus is switched to the second display mode comprises a sensor for sensing the position of the polariser.

16. Control apparatus according to claim 14, wherein the optical switching apparatus is switchable between the first and second display modes by electrical driving of a polarising element, and the means for determining that the optical switching apparatus is switched to the second display mode comprises means for determining the electrical driving of the polarising element.

17. Control apparatus according to claim 14, wherein the second display mode provides a distinct image at each of the plurality of different viewing windows by driving adjacent columns with data from distinct images; and the means for driving the display using a driving scheme arranged to display the image such that the distinct images at each of the plural viewing windows in the second display mode are substantially the same as each other comprises means for applying the same data from the image to be displayed to adjacent columns.

18. Control apparatus according to claim 17, wherein the means for applying the same data from the image to be displayed to adjacent columns comprises:
(iv) means for latching or sampling the column data; and
(v) means for controlling the latching or sampling by a clock signal related in frequency and phase to a horizontal clock of the optical switching apparatus.

19. Control apparatus according to claim 18, wherein the means for latching or sampling the column data and the means for controlling the latching or sampling by a clock signal related in frequency and phase to a horizontal clock of the optical switching apparatus are adapted to latch or sample, and to control latching or sampling, for each colour channel.

20. Control apparatus according to claim 14, wherein the means for driving the display using a driving scheme arranged to display the image such that the distinct images at each of the plural viewing windows in the second display mode are substantially the same as each other is able to provide the driving scheme for only a portion of a display area of the optical switching apparatus.

21. Control apparatus according to claim 14, further comprising means for receiving the image data of the image to be displayed from a remote source.

22. Control apparatus according to claim 14, further comprising means for monitoring the optical switching apparatus being in or being switched to the second display mode.

23. Control apparatus according to claim 22, further comprising means for communicating, to a remote entity, monitored data related to the optical switching apparatus being in or being switched to the second display mode.

24. Control apparatus according to claim 14, wherein the first display mode provides a 2D image and the second display mode provides a 3D autostereoscopic image.

25. Control apparatus according to claim 14, wherein the means for determining that an image to be displayed is not authorised to be displayed with a distinct image at each of the plurality of different viewing windows comprises means for identifying a flag in data associated with the image data.

26. Control apparatus according to claim 14, wherein the means for determining that an image to be displayed is not authorised to be displayed with a distinct image at each of the plurality of different viewing windows comprises means for processing a user input.

27. An optical switching apparatus comprising control apparatus according to claim 14 and a spatial light modulator.

28. An optical switching apparatus comprising a graphics controller, a connection module comprising control apparatus according to claim 14, and a spatial light modulator, the graphics controller being connected to the spatial light modulator via the connection module.

29. A portable electronic device comprising an optical switching apparatus according to claim 27.

30. A storage medium storing processor-implementable instructions capable of controlling one or more processors to carry out the method of claim 1.
